(19) United States
(12) Patent Application Publication
(10) Pub. No.: US 2010/0303631 A1
(43) Pub. Date: Dec. 2, 2010

(54) Wind Turbine Rotor Blade Having Segmented Tip

(75) Inventors: Christopher Gordon Thomas Payne, Clevedon (GB); Amaury Denis Vuillaume, Cowes Isle of Wight (GB)

Correspondence Address: COHEN, PONTANI, LIEBERMAN & PAVANE LLP, 551 FIFTH AVENUE, SUITE 1210, NEW YORK, NY, 10176, US

(73) Assignee: Vestas Wind Systems A/S

(21) Appl. No.: 12/486,372

(22) Filed: Jun. 17, 2009

(30) Foreign Application Priority Data
May 29, 2009 (GB) GB0909192.7

(51) Int. Cl. F03D 1/06; F03D 3/06

(52) U.S. Cl. 416/226

(57) ABSTRACT

A wind turbine rotor blade is provided. The rotor blade comprises a root portion located in a proximal region of the rotor blade and a tip portion connected to the root portion and located in a distal region of the rotor blade. A spar extends from the root portion to the tip portion. The spar is a unitary member at the root portion and separates into a primary spar and a sub-spar towards the tip region of the rotor blade. Each spar and sub-spar has a respective lifting surface of the rotor blade associated therewith, each lifting surface being distinct from each other lifting surface.

### FIELD OF THE INVENTION

The present invention relates to the field of wind turbine rotor blades, in particular, to rotor blades having segmented tips to thereby address structural loading issues.

### DESCRIPTION OF THE RELATED ART

A conventional wind turbine rotor blade 2 is illustrated in FIG. 1. The rotor blade 2 comprises a root portion 4 configured to be connectable to a hub of a wind turbine generator and a tip portion 6 extending from the root portion as shown. Wind turbine rotor blades are generally increasing in size as they continue to be developed and improved. Such increases in magnitude result in a number of problems, some of which relate to space and equipment required to manufacture the blades and also to the size of vehicles required to transport finished blades.

It is, therefore, desirable to reduce or at least limit increases to the size of the main rotor blade 2.

In order to increase the productivity of a wind turbine generator, it is generally considered desirable to enhance the efficiency of a tip portion 6 of the blade 2 as a disproportionate amount of lift energy captured by the blade 2 is effected at the tip portion 6 of the blade. As the lift generated by the tip portion 6 is further increased, by virtue of this enhanced efficiency, it follows that additional structural loads are experienced in the tip region and it is necessary to transmit these loads along the length of the rotor blade 2. Such additional loading requires the rotor blade to be reinforced.

As a consequence, the primary structure 8 of the rotor blade 2 that supports the extreme tip portion 6 becomes more substantial and, therefore, heavier. This increased weight of the rotor blade 2 poses additional problems for a wind turbine installation, to which the rotor blade is connected in use via a hub. Namely, the structural loading experienced by the hub and mechanisms contained therein is correspondingly increased and must therefore, in turn, be further reinforced.

### SUMMARY OF THE INVENTION

It is desirable to enhance the efficiency of the rotor blade tip to thereby increase the productivity of the rotor blade without substantially increasing the structural loading experienced by the remainder of the rotor blade. In so doing, reinforcement of the rotor blade can be substantially avoided.

According to a first aspect, the present invention provides a wind turbine rotor blade comprising:
a root portion located in a proximal region of the rotor blade;
a tip portion connected to the root portion and located in a distal region of the rotor blade;
a spar extending from the root portion to the tip portion, wherein the spar is a unitary member at the root portion and separates into a primary spar and a sub-spar towards the tip region of the rotor blade, each spar and sub-spar having associated therewith a respective lifting surface of the rotor blade, each lifting surface being distinct from each other lifting surface.

By providing a rotor blade having a spar that separates from a unitary member into separate primary and sub-spar members, the tip region of the rotor blade is able to be represented by more than one lifting surface. In so doing, detrimental aerodynamic features generally associated with a tip region of a rotor blade can be mitigated. Furthermore, forces experienced by respective lifting surfaces can be transmitted back to the main spar in a distributed fashion, thus dispersing the loads experienced by a support structure of the rotor blade.

The lifting surface may be releasably mounted on the rotor blade or it may be integral therewith. By having a releasable lifting surface, the span of the rotor blade may be reduced, leading to corresponding benefits in manufacture and transportation resulting from smaller footprint components.

The spar may comprise a second sub-spar. Separation of a first sub-spar may occur at a first span-wise location and separation of a second sub-spar may occur at a second span-wise location. By providing connections or joints between respective sub-spars at different span-wise locations of the rotor blade, dispersion of load paths associated with transmission of forces experienced by the lifting surfaces may be further enhanced.

According to a second aspect, the present invention provides a wind turbine installation comprising:
a tower;
a hub mounted atop the tower; and
a wind turbine rotor blade of the aforementioned type, connected to the hub.

### BRIEF DESCRIPTION OF THE DRAWINGS

The present invention will now be described, by way of example only, with reference to the accompanying drawings in which:

FIG. 1 illustrates a schematic representation of a conventional rotor blade;

FIG. 2 represents a rotor blade having three distinct rotor blade tips; and

FIG. 3 illustrates a means of attachment of a rotor blade sub-spar member to a spar of the rotor blade.

### DETAILED DESCRIPTION OF THE DRAWINGS

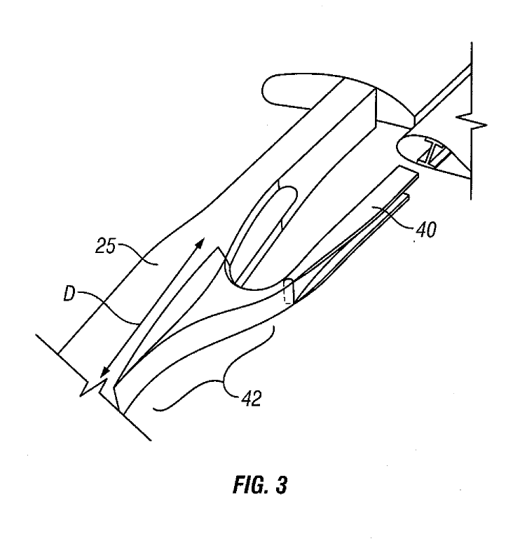

FIG. 2 represents a rotor blade 10 having a root region 15 and a tip region 20. The rotor blade 10 is structurally supported by a spar 25. A conventional spar is a unitary structure extending from a proximal part of the root region 15 of the rotor blade, to be attached to a hub, in use, to a distal part of the tip region 20.

In one embodiment, the spar 25 comprises a primary spar member 30 and two sub-spar members 35, 40. The first sub-spar member 35 separates from the primary spar member 30 at a mid-section of a span of the rotor blade 10. The first sub-spar member 35 is located upstream of the main spar member 30 and extends into a leading edge portion of the rotor blade 10. A second sub-spar member 40 separates from the primary spar member 30 in a region roughly 20-25% of the length of the span when measured from a proximal part of the root region 15. The second sub-spar 40 extends aft of the primary spar member 30 and, therefore, extends into a trailing edge portion of the rotor blade 10.

FIG. 3 illustrates one example of a connection between the spar 25 and a sub-spar 40. In this example, a proximal portion 42 of the second sub-spar 40 is configured to diverge, thus extending the area D over which load is transmitted from the sub-spar 40 to the spar 25.

Returning to FIG. 2, a skin 45 is formed about the spar 25 and substantially encapsulates the primary spar 30 and sub-spar members 35, 40 to thereby define an outer envelope or lifting surface of the rotor blade 10.

In this embodiment, the lifting surface or skin 45 continues to an extreme distal portion of the tip region 20 and defines a central or primary lifting surface 50 located about the primary spar member 30. Separable tip portions 55, 60 are provided over a distal portion of each of the sub-spar members 35, 40. A leading edge tip portion 55 is associated with the leading edge sub-spar member 35 whilst a trailing edge tip portion 60 is associated with the trailing edge sub-spar member 40. Each tip portion 55, 60 are formed from moulded panels and are configured to be fastened or bonded to the primary lifting surface 50 using conventional means.

In operation, the rotor blade 10, is attached to a hub of a wind turbine installation (not shown) and is rotated thereby. The rotor blade 10, therefore passes through the air extracting energy therefrom. The root region 15 of the rotor blade 10 experiences significantly lower relative wind speeds than those experienced by the extreme distal portion of the tip region 20. As the tip region 20 of the rotor blade 10 experiences higher relative wind speeds, it follows that an increased amount of lift is generated at the tip region 20 of the rotor blade 10.

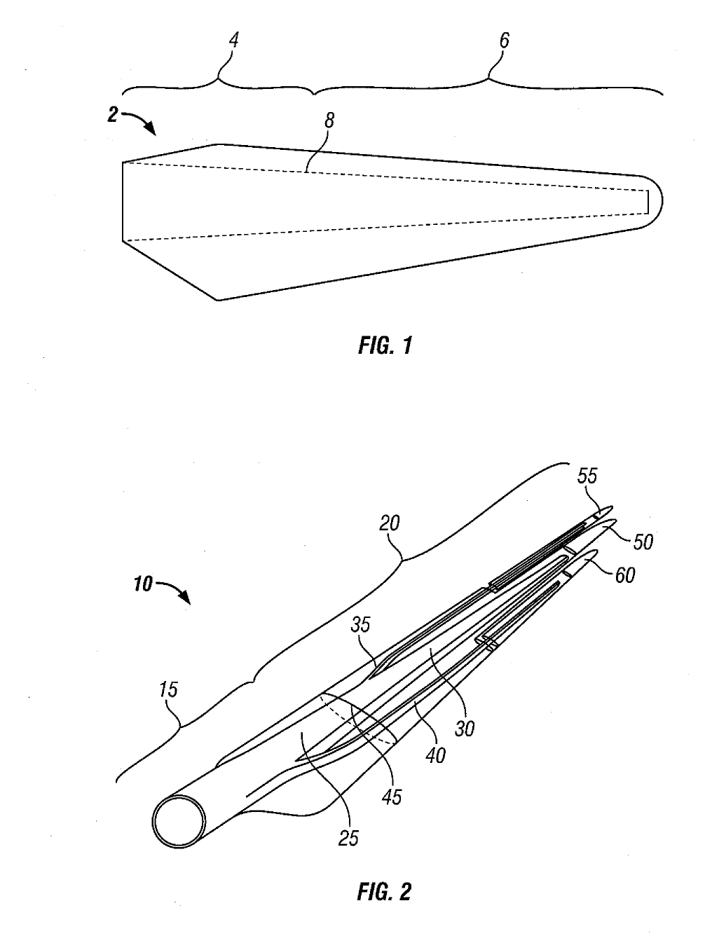

In a conventional rotor blade 2 (referring back to FIG. 1), having a single tip portion 6, significant differences in pressure are experienced across a thickness of the rotor blade. In other words, a significantly elevated pressure is experienced by a so called “pressure side” of the rotor and a reduced pressure is experienced by the so called “suction side” of the rotor blade 2 due to the speed of the fluid passing over each respective surface. The resulting pressure difference causes a redistribution of air from the pressure side to the suction side resulting in a circulation of air flow about the extreme rotor tip. Such circulation initiates the formation of tip vortices by each respective rotor blade 2. A conventional tip vortex of this type is shed from the extreme rotor tip and generates a significant amount of drag. The drag not only counteracts/negates some of the lift generated by the tip region 6 but can also result in significant noise being generated by the tip region of a wind turbine rotor blade 2.

By providing a number of distinct tip portions 50, 55, 60 of the rotor blade 10, the magnitude of each tip vortex generated by the rotor blade 10 is significantly reduced leading to a substantial overall reduction in drag. Further benefit is gained from providing a number of smaller tip vortices in that the tip vortices interact with one another thus disrupting the structure of each individual vortex and, hence, lessening the impact thereof.

As the magnitude of rotor blades is increased it is desirable to consider means for reducing the size thereof for manufacture and transportation. Provision of a rotor blade having a separable/removable tip portion may be considered such that a span-wise extent of the blade may be reduced. However, in operation of a so configured rotor blade, significant structural loading would be focused at the junction between the tip portion and the remainder of the blade such that significant local reinforcement (and associated additional weight) is located at this junction. By dividing the unitary spar member found at the root region 15 into a primary spar 30 and at least one sub-spar 35, 40 by the extreme tip region of the rotor blade 10, it becomes possible to provide more than one removable tip portion 50, 55, 60. In so doing, the loading of the primary spar 30 becomes distributed in one, or each, of two ways. Firstly, each tip portion 50, 55, 60 may have a different span-wise extent and so the junctions in the lifting surface are positioned at different span-wise locations. Secondly, the, or each, sub-spar 35, 40 connects to the primary spar 30 at a different respective span-wise location. The loading is, therefore transmitted from each tip portion to the rotor blade in a distributed manner.

In summary, each distinct tip portion 50, 55, 60 generates its own dedicated amount of lift. As for a conventional rotor blade 2, the forces experienced by the tip region 20 (from generating lift) must be transmitted along the span of the rotor blade 10 to the root region 15, and from there to a hub of the wind turbine installation. By separating the rotor blade tip into three distinct portions, each respective portion can be attached to the rotor blade 10 at a different span-wise location. Consequently, the structural load transmitted from each respective removable tip 55, 60 is distributed such that the structural loading experienced by the rotor blade 10 is dispersed.

Consequently, it is not necessary to reinforce the rotor blade to the same extent as would be required if a single removable tip portion were implemented.

The invention has been described with reference to specific examples and embodiments. However, it should be understood that the invention is not limited to the particular examples disclosed herein but may be designed and altered within the scope of the invention in accordance with the claims.

What is claimed is:

1. A wind turbine rotor blade comprising:
a root portion located in a proximal region of the rotor blade;
a tip portion connected to the root portion and located in a distal region of the rotor blade;
a spar extending from the root portion to the tip portion, wherein the spar is a unitary member at the root portion and separates into a primary spar and a sub-spar towards the tip region of the rotor blade, each spar and sub-spar having associated therewith a respective lifting surface of the rotor blade, each lifting surface being distinct from each other lifting surface.

2. A rotor blade according to claim 1, wherein at least one said lifting surface is releasably mounted on the rotor blade.

3. A rotor blade according to claim 1, wherein the spar comprises a second sub-spar.

4. A rotor blade according to claim 3, wherein separation of a first sub-spar occurs at a first span-wise location and separation of a second sub-spar occurs at a second span-wise location.

5. A wind turbine rotor blade substantially as herein described and with reference to the accompanying drawings.

6. A wind turbine installation comprising:
a tower;
a hub mounted atop the tower; and
a wind turbine rotor blade, according to claim 1, connected to the hub.
